(19) United States
(12) Patent Application Publication
(10) Pub. No.: US 2010/0247812 A1
(43) Pub. Date: Sep. 30, 2010

(54) TRANSPARENT POLYCRYSTALLINE SPINEL SUBSTRATE AND METHOD OF PRODUCING SAME, AND OPTICAL ARTICLE USING SAID SUBSTRATE

(75) Inventors: Masashi Yoshimura, Itami-shi (JP); Takenori Yoshikane, Osaka-shi (JP); Akihito Fujii, Osaka-shi (JP); Shigeru Nakayama, Osaka-shi (JP)

Correspondence Address: GLOBAL IP COUNSELORS, LLP, 1233 20TH STREET, NW, SUITE 700, WASHINGTON, DC, 20036-2680, US

(73) Assignee: SUMITOMO ELECTRIC INDUSTRIES, LTD., Osaka-shi, Osaka (JP)

(21) Appl. No.: 12/744,039

(22) PCT Filed: Nov. 21, 2008
(86) PCT No.: PCT/JP2008/071233

§ 371 Date: May 20, 2010

(30) Foreign Application Priority Data
Nov. 26, 2007 (JP) 2007-304252

(51) Int. Cl. C09K 19/00; B28B 3/00

(52) U.S. Cl. 428/1.62; 264/604

(57) ABSTRACT

There is provided a transparent polycrystalline spinel substrate characterized in having a transmittance of 0.005% or less in a crossed Nicol system at a thickness of 1 mm and a wavelength of 450 nm, which does not generate image blurring or light-dark change when used in optical products. There is also provided a method for producing the transparent polycrystalline spinel substrate comprising a step for preparing a spinel powder, a step for molding the spinel powder and producing a spinel formed body, a step for sintering the spinel formed body and producing a spinel sintered body, and a step for subjecting the spinel sintered body to hot isostatic pressing (HIP) and producing a spinel polycrystalline body. There is further provided a liquid crystal projector and a receiver for rear-projection television having the aforementioned transparent polycrystalline spinel substrate.

### TECHNICAL FIELD

The present invention relates to a transparent polycrystalline spinel substrate and a method of producing the same, and particularly relates to a transparent substrate for liquid crystal projectors and receivers for rear-projection television, and other transparent polycrystalline spinel substrates used in optical applications, and to a method for producing the same. The present invention further relates to a liquid crystal projector and a receiver for rear-projection television that use the transparent polycrystalline spinel substrate.

### BACKGROUND ART

Over the past several years, liquid crystal projectors and receivers for rear-projection television have become commercially available. In these products, the front and back sides of a liquid crystal screen are made transparent, one side acting as a liquid crystal panel is exposed to light, and the transmitted light is adjusted by a lens or the like. Transparent substrates for protecting liquid crystal screens in these types of liquid crystal projectors and the like are required not only to merely protect the liquid crystal screens from dirt or air, but also to provide thermal protection from the adjacent light source, to release the heat of rising temperatures accompanying the phenomenon of heat absorption generated in the liquid crystal screen by the light from the light source, and the like.

Transparent polycrystalline spinel substrates are disclosed in Patent Documents 1 through 3 and elsewhere as transparent substrates having excellent light transmission characteristics. The transparent polycrystalline spinel substrates have excellent transparency, absorb little light-induced heat from the aforementioned light source, and can release and disperse the heat of the rising temperature of the liquid crystal, and therefore are useful as transparent substrates in liquid crystal projectors and the like.

[Patent Document 1] Japanese Published Examined Application No. 6-72045

[Patent Document 2] Japanese Laid-open Patent Publication No. 2006-273679

[Patent Document 3] Japanese Translation of PCT International Application No. 4

### SUMMARY OF THE INVENTION

### Technical Problem

However, when liquid crystal projectors and other optical products are produced using these transparent polycrystalline spinel substrates, image blurring and light-dark change are sometimes generated, and problems are encountered in obtaining a product having stable characteristics.

Accordingly, the present invention is intended to provide a transparent polycrystalline spinel substrate in which image blurring and light-dark change do not occur when the substrate is used as an optical product. The present invention is also intended to provide a method for producing such a transparent polycrystalline spinel substrate. The present invention is further intended to provide a liquid crystal projector and a receiver for rear-projection television using such a transparent polycrystalline spinel substrate.

### Solution to Problem

The present inventors conducted a thorough investigation regarding the cause of image blurring and light-dark change in liquid crystal projectors using the aforementioned conventional transparent polycrystalline spinel substrate. As a result, they discovered that although the conventional belief is that a spinel material (MgO.nAl₂O₃; n=1 to 3) does not have polarization properties in crystallographic terms due to its cubic crystal structure, in reality a small amount of scattering is generated.

The present inventors conducted an investigation as to the cause of the slight polarization properties generated, and discovered as a result that the production process and nonuniformity and the like in the density of conventional transparent polycrystalline spinel substrates generate a microscopic texture having very small voids, and this microscopic texture causes the aforementioned small amount of scattering to be generated.

On the basis of the aforementioned investigative results, the present inventors conducted a further investigation in order to precisely determine the variations in the scattering characteristics. They discovered that the variations in the scattering characteristics can be precisely determined by using as an index the transmittance in a crossed Nicol system of a sintered body or a spinel formed body as a substrate. Furthermore, the present inventors developed the present invention upon discovering a specific transmittance in a crossed Nicol system capable of providing a transparent polycrystalline spinel substrate that does not generate image blurring or light-dark change when used as an optical product.

Aspects of the present invention are described in detail below.

A first aspect of the invention of the present application is a transparent polycrystalline spinel substrate characterized in having a transmittance of 0.005% or less in a crossed Nicol system at a thickness of 1 mm and a wavelength of 450 nm.

In determining the above-described transmittance in a crossed Nicol system, the transmission axis of the polarizing plate near the detector is first set to 90° (in other words, orthogonally) relative to the polarizing plate near the light source, light of a predetermined wavelength is emitted from the light source, the transmittance is calculated, and the value thereof assumed to be the blank value, as shown in FIG. 1(a). A sample to be measured is subsequently inserted between the two polarizing plates as shown in FIG. 1(b), light is emitted in the same manner, and the difference between the sample value and the blank value is defined as the transmittance in a crossed Nicol system.

The present inventors conducted an investigation specifically to obtain the transmittance in an appropriate crossed Nicol system capable of being used in a projector. As a result, it was discovered that the transmittance in a crossed Nicol system can be brought to 0.005% or lower at a thickness of 1 mm and a wavelength of 450 nm.

Specifically, since the transmittance in a crossed Nicol system is 0.005% or less at a thickness of 1 mm and a wavelength of 450 nm in the first aspect of the invention of the present application, it is possible to provide a transparent polycrystalline spinel substrate that generates substantially no image blurring or light-dark change when used as an optical product.

It is also possible to provide a transparent substrate having excellent transparency and better polarization properties than those of polarizable sapphire.

A second aspect of the invention of the present application is the transparent polycrystalline spinel substrate according to the first aspect, characterized in that the density is 3.58 g/cm³ or greater.

Since the density is 3.58 g/cm³ or greater in the invention of the second aspect, the transmittance in a crossed Nicol system is 0.005% or less at a thickness of 1 mm and a wavelength of 450 nm.

Specifically, the 3.58 g/cm³ density of the transparent polycrystalline spinel substrate corresponds to a theoretical density ratio (percentage relative to the true density of 3.6) of 99.5 or greater.

In the invention of the second aspect, since the theoretical density ratio is set to be higher than the theoretical density ratio of 99.3% in a conventional product, very small voids are extremely few to the point of being substantially absent from the transparent polycrystalline spinel substrate, and the voids that are present are extremely small, for which reason there is substantially no effect on the scattering characteristics. It is therefore possible to provide a good transparent polycrystalline spinel substrate without scattering.

The high theoretical density ratio can also improve the transmittance, making it possible to provide a transparent polycrystalline spinel substrate that has excellent transparency and does not generate image blurring or light-dark change in the invention of the second aspect.

A third aspect of the invention of the present application is the transparent polycrystalline spinel substrate according to the first or second aspect, characterized in that the transmittance at a wavelength of 450 nm is 82% or greater at a thickness of 1 mm.

Since the transmittance at a wavelength of 450 nm is 82% or greater at a thickness of 1 mm in the invention of the third aspect, it is possible to provide the aforementioned transparent polycrystalline spinel substrate having excellent transparency.

A fourth aspect of the invention of the present application is the transparent polycrystalline spinel substrate according to any of the first through third aspects, characterized in that at least one side is provided with an antireflection coating, and the transmittance in a crossed Nicol system is 0.005% or less at a thickness of 1 mm.

Since the transmittance in a crossed Nicol system of the transparent polycrystalline spinel substrate integrated with the antireflection coating provided to one side is 0.005% or less at a thickness of 1 mm in the invention of the fourth aspect, it is possible to provide a transparent polycrystalline spinel substrate having better in-line transparency.

MgF₂, YF₃, LaF₃, CeF₃, BaF₂, or another metal fluoride is preferably used for the antireflection coating. Multilayering with SiO₂, TiO₂, Al₂O₃, Y₂O₃, Ta₂O₅, ZrO₂, and other metal oxides is also possible.

A physical vapor deposition method can be used as the means for providing the antireflection coating; specific examples include sputtering methods, ion plating methods, and vacuum deposition methods.

A fifth aspect of the invention of the present application is the transparent polycrystalline spinel substrate according to the fourth aspect, characterized in that the transmittance at a wavelength of 450 nm is 91% or greater at a thickness of 1 mm.

Since the transmittance at a wavelength of 450 nm is 91% or greater at a thickness of 1 mm in the invention of the fifth aspect, it is possible to provide the above-described transparent polycrystalline spinel substrate having excellent scattering characteristics as well as excellent transparency.

In the invention of the fifth aspect, the target transparent polycrystalline spinel substrate is the transparent polycrystalline spinel substrate according to the fourth aspect, and an antireflection coating is provided, making it possible to obtain higher transmittance than in the transparent polycrystalline spinel substrate provided in the first through third aspects.

A sixth aspect of the invention of the present application is a method for producing the transparent polycrystalline spinel substrate according to any of the first through fifth aspects, the method for producing the transparent polycrystalline spinel substrate characterized in comprising:

a step for preparing a spinel powder;

a step for molding the spinel powder and producing a spinel formed body;

a step for sintering the spinel formed body and producing a spinel sintered body; and

a step for subjecting the spinel sintered body to hot isostatic pressing (HIP) and producing a spinel polycrystalline body.

A high-density spinel polycrystalline body can be obtained in the invention of the sixth aspect by providing the step for sintering the spinel formed body and producing a spinel sintered body, and the step for subjecting the spinel sintered body to hot isostatic pressing (HIP) and producing a spinel polycrystalline body.

The sintering is preferably performed under a vacuum. Sintering under a vacuum makes it possible to reduce nonuniformity and strain in the crystal lattice caused by the removal of holes and the presence of microscopic impurities, and can minimize the generation of very small voids.

Using hot isostatic pressing makes it possible to reduce the size of the very small voids even further. As a result, it is possible to obtain a high-density spinel polycrystalline body.

The resulting spinel polycrystalline body is further subjected to the mirror-like finishing and other types of surface finishing generally related to optical products, whereby it is possible to ultimately obtain a transparent polycrystalline spinel substrate having low transmittance in a crossed Nicol system, i.e., excellent in-line transparency characteristics.

The preferred conditions under which the spinel formed body is sintered are, for example, a degree of vacuum of about 1 to 200 Pa, and a temperature of about 1500 to 1750° C.

The preferred conditions for the HIP step are, for example, those in which the atmosphere is argon gas, oxygen, nitrogen, or the like; the temperature is about 1800 to 1900° C.; and the pressurizing force is about 5 to 200 MPa.

There are no particular limits imposed on the conditions for the various steps mentioned above, as long as the conditions are set so as to ultimately satisfy the first through fifth aspects.

Other steps may be added as desired to the steps described above, depending on the characteristics and the like of the transparent polycrystalline spinel substrate.

A seventh aspect of the invention of the present application is the transparent polycrystalline spinel substrate according to any of the first through fifth aspects, characterized in being for use in a liquid crystal projector or a receiver for rear-projection television.

In the invention of the seventh aspect, applying the transparent polycrystalline spinel substrate according to any of the first through fifth aspects to a polarizing plate or the like for a liquid crystal projector or a receiver for rear-projection television makes it possible to provide an excellent liquid crystal projector or a receiver for rear-projection television.

An eighth aspect of the invention of the present application is a liquid crystal projector or a receiver for rear-projection television having the transparent polycrystalline spinel substrate according to any of the first through fifth aspects.

According to the invention of the eighth aspect, it is possible to provide a liquid crystal projector or a receiver for rear-projection television having the transparent polycrystalline spinel substrate according to any of the first through fifth aspects, in which substantially no image blurring or light-dark change is generated.

### EFFECT OF THE INVENTION

According to the present invention, it is possible to provide a transparent polycrystalline spinel substrate that does not generate image blurring or light-dark change when used as an optical product.

Using this type of transparent polycrystalline spinel substrate makes it also possible to provide a liquid crystal projector and a receiver for rear-projection television in which substantially no image blurring or light-dark change is generated.

### BRIEF DESCRIPTION OF DRAWINGS

FIG. 1 is a view illustrating transmittance in a crossed Nicol system; and

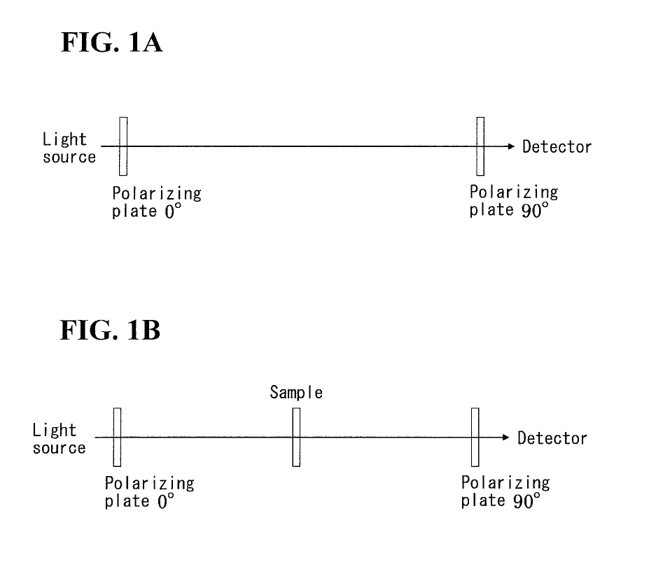

FIG. 2 is a view schematically showing the structure of a liquid crystal projector.

### KEY

50 Light source
51 Reflecting mirror
53 Infrared focusing lens
54 Ultraviolet cut filter
60 Polarization conversion integrator
61 Fly eye lens
62 Slit
63 Lens
70 Dichroic mirror
71 Mirror
80 Liquid crystal panel
81 Polarizing plate
82 Dust-proofing window
83 Half-wave plate
84 Cross-dichroic prism
90 Projection lens system

### DESCRIPTION OF THE PREFERRED EMBODIMENTS

A preferred embodiment of the present invention is described in more detail below on the basis of the examples shown hereinafter. The present invention is not limited to the embodiment described below. A variety of modifications may be added to the below-described embodiment within a scope that is identical and equivalent to the present invention.

a. Step for Preparing and Molding Spinel Powder to Produce a Spinel Formed Body

Spinel powder (average particle diameter: 0.2 μm) having a purity of 99.9% or greater was pressed at a pressure of 98 MPa, after which cold isostatic pressing (CIP) was performed at 196 MPa, creating a spinel formed body measuring 50 mm (diameter)×10 mm.

b. Step for Sintering the Spinel Formed Body in a Vacuum and Producing a Spinel Sintered Body

The resulting spinel formed body was kept in a vacuum at a temperature of 1670° C. for two hours, producing a spinel sintered body.

c. Step for Performing Hot Isostatic Pressing on the Spinel Sintered Body and Producing a Polycrystalline Spinel Body

The resulting spinel sintered body was kept under an argon atmosphere at the temperatures shown in Table 1 for two hours, hot isostatic pressing (HIP) was performed, and polycrystals were formed, producing spinel polycrystalline body sample Nos. 1 to 4. The pressure in all of the cases was 200 MPa.

The density of the resulting samples was measured using the Archimedean method. The measurement results are summarized in Table 1.

d. Production of Transparent Polycrystalline Spinel Substrate

The resulting samples were subjected to mirror-like finishing to a thickness of 1.0 mm, MgF₂ was subsequently applied to one side of each in a thickness of 0.1 μm to provide an antireflection coating, and transparent polycrystalline spinel substrates were produced using the samples.

e. Measuring the Transmittance [of Substrates] and Transmittance in a Crossed Nicol System

The transmittance of the resulting transparent polycrystalline spinel substrates was measured at a wavelength of 450 nm. A spectral photometer (UV 4100) produced by Hitachi High-Technologies Corporation was used to perform the measurement.

Next, the transmittance in a crossed Nicol system was measured at a wavelength of 450 nm using the same spectral photometer.

The measurement results for the transmittance [of the substrates] and transmittance in a crossed Nicol system are summarized in Table 1.

TABLE 1

| | HIP | | | Transmittance in |
|---|---|---|---|---|
| | temperature | Density | Transmittance | crossed Nicol |
| Sample | (° C.) | (g/cm³) | (%) | system (%) |
| No. 1 | 1700 | 3.575 | 91.5 | 0.010 |
| No. 2 | 1750 | 3.578 | 92.0 | 0.008 |
| No. 3 | 1800 | 3.580 | 91.8 | 0.001 |
| No. 4 | 1850 | 3.582 | 91.5 | 0.002 |

Nos. 1 and 2 in Table 1 are comparative examples in which the transmittance in a crossed Nicol system exceeds 0.005%, and Nos. 3 and 4 are examples based on the present invention.

As shown in Table 1, transparent polycrystalline spinel substrate Nos. 1 through 4 all show a transmittance of 91% or greater, indicating that these are highly transparent polycrystalline spinel substrates.

It can be seen that the transparent polycrystalline spinel substrates having a density of 3.58 g/cm³ or greater (Nos. 3 and 4) show far lower transmittance in a crossed Nicol system than do transparent polycrystalline spinel substrates having a density lower than 3.58 cm³ (Nos. 1 and 2).

It can be seen from the above that a very good transparent polycrystalline spinel substrate having excellent transparency and low transmittance in a crossed Nicol system can be obtained by increasing the density.

It should be noted that the transmittance of No. 4 in Table 1 and transmittance in a crossed Nicol system are worse than that of No. 3, which has a lower density than No. 4. The reason is posited as described below.

Specifically, voids become smaller and the adverse effects on the polarization properties become less pronounced with increased density (theoretical density ratio). However, it is posited that a further increase in the density (theoretical density ratio) leads to a state in which the microscopic voids move next to each other and ultimately merge together, becoming one void larger in size than before the merging, and this has an adverse effect on the transmittance [of the substrates] and the transmittance in a crossed Nicol system.

(Incorporation into Liquid Crystal Projector and Evaluation)

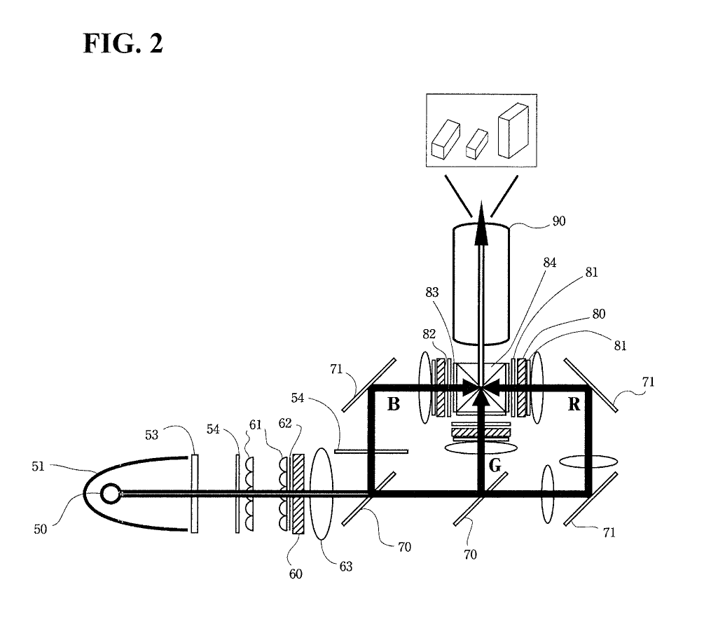

Transparent polycrystalline spinel substrate Nos. 3 and 4 were incorporated into a liquid crystal projector whose structure is schematically shown in FIG. 2, and were evaluated.

Reference numeral 50 in FIG. 2 indicates a metal halide lamp, xenon lamp, ultra-high performance (UHP) lamp, or other high-intensity lamp, 51 is a reflecting mirror, 53 is an infrared focusing lens, 54 is an ultraviolet cut filter, 60 is a polarization conversion integrator, 61 is a fly eye lens, 62 is a slit, 63 is a lens, 70 is a dichroic mirror for transmitting and reflecting light in accordance with the wavelength thereof, 71 is a mirror, 80 is a liquid crystal panel, 81 is a polarizing plate, 82 is a dust-proofing window, 83 is a half-wave plate, 84 is a cross-dichroic prism, and 90 is a projection lens system.

Light from the light source 50 is reflected by the reflecting mirror 51 and focused by the infrared focusing lens 53. Unnecessary ultraviolet rays are cut by the ultraviolet cut filter 54, luminance nonuniformities are smoothed by two fly eye lenses 61, and the light is guided to the polarization conversion integrator 60, which has a polarizing beam splitter and a half-wave plate, via the slit 62. The light subsequently passes through the lens 63 and is resolved into the three primary colors red, green, and blue by the two dichroic mirrors 70. The resolved three primary colors each pass through the mirror 71 or the like; are guided separately to an optical switch having a polarization plate 81, the liquid crystal panel 80, the dust-proofing window 82, and a polarization plate 81; further pass through the half-wave plate 83; and are combined together by the cross-dichroic prism 84. The composite light is guided to the projection lens system 90 and is projected in magnified form to show an image on a forward screen.

The transparent polycrystalline spinel substrates were used in the ultraviolet cut filter 54, the fly eye lens 61, the lens 63, the dichroic mirror 70, the retaining plate of the polarizing body in the polarization conversion integrator 60 and the polarizing plate 81, the transparent substrate constituting the liquid crystal panel 80, and the dust-proofing window 82 of the above-described liquid crystal projector. Upon evaluation, it could be confirmed that the transparent polycrystalline spinel substrates are suitable for use in optical products without generating image blurring or light-dark change.

A transparent polycrystalline spinel substrate that does not generate image blurring or light-dark change when used in optical products can thus be provided according to the present invention. The transparent polycrystalline spinel substrate of the present invention can be suitably used, for example, in parts (polarizing plate 81, dust-proofing window 82, and the like in the example of FIG. 2) where transparent substrates are used in a liquid crystal projector, and in a variety of other components.

1. A transparent substrate comprising:
a spinel polycrystalline body having a light transmittance of 0.005% or less in a crossed Nicol system at a thickness of 1 mm and a wavelength of 450 nm.

2. The transparent substrate according to claim 1, wherein the spinel polycrystalline body has having a density of 3.58 g/cm³ or greater.

3. The transparent substrate according to claim 1, wherein the light transmittance of the spinel polycrystalline body at a wavelength of 450 nm is 82% or greater at a thickness of 1 mm.

4. The transparent substrate according to claim 1, wherein, characterized at least one side of the spinel polycrystalline body is provided with an antireflection coating, and the transmittance in a crossed Nicol system is 0.005% or less at a thickness of 1 mm.

5. The transparent substrate according to claim 4, wherein the light transmittance of the spinel polycrystalline body at a wavelength of 450 nm is 91% or greater at a thickness of 1 mm.

6. A method for producing the transparent substrate according to claim 1, the method for producing the transparent polycrystalline spinel substrate comprising:
preparing a spinel powder;
molding the spinel powder and producing a spinel formed body;
sintering the spinel formed body and producing a spinel sintered body; and
subjecting the spinel sintered body to hot isostatic pressing and producing a spinel polycrystalline body.

7. (canceled)

8. (canceled)

9. The method for producing the transparent substrate according to claim 6, further comprising:
applying an antireflection coating to at least one side of the spinel polycrystalline body.

10. A receiver for a rear-projection television comprising the transparent substrate according to claim 1.

11. A liquid crystal projector for rear-projection television comprising the transparent substrate according to claim 1.
